(19) United States
(12) Patent Application Publication
(10) Pub. No.: US 2008/0047500 A1
(43) Pub. Date: Feb. 28, 2008

(54) Pet Door and Removable Pesticide Applicator

(76) Inventor: Kersten Conway, League City, TX (US)

Correspondence Address: JOHN K. BUCHE, 7777 FAY AVENUE, SUITE 205, LA JOLLA, CA, 92037, US

(21) Appl. No.: 11/676,156

(22) Filed: Feb. 16, 2007

Related U.S. Application Data
(60) Provisional application No. 60/839,989, filed on Aug. 24, 2006.

(51) Int. Cl. A01K 29/00

(52) U.S. Cl. 119/652

(57) ABSTRACT

A pesticide applicator for use on a pet door featuring an affixing means operationally configured to secure the pesticide applicator to a pet door, an applicator surface disposed on the pesticide applicator, where the applicator surface is configured to receive and dispense pesticides on a pet passing through or near said pet door.

This application claims priority from provisional patent application No. 60/839,989 filed on Aug. 24, 2006.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present application relates to the field of pet doors and pesticide applicators for pets.

2. Background of the Invention

Pet doors are a common feature of doors and/or structures that allow pets to freely enter and exit the structure without the necessity of human intervention. As any door, when closed, the pet door maintains the seal of the structure and generally protects the interior of the structure from outdoor elements. A pet door remains closed until the pet uses the door, and automatically closes behind the pet when the pet exits or enters the structure. This is a convenience for pets, since the pet does not require the assistance of the owner to enter or exit a structure, and a convenience to the pet owner, who does not need to open and close doors for the pet.

Pesticides are chemicals used to kill or simply deter pests, particularly insects. Pesticides are commonly used on pets to eliminate, deter or dislodge insects or other pests that may attach themselves on or in the pet. Pesticides are applied to pets in a variety of ways and are available in a variety of forms. Pesticides can be beneficial to the overall health of the animal and are beneficial to owners, particularly those owners keeping pets that travel indoors and outdoors. Pesticides can be useful to prevent pests, including but not limited to fleas and ticks, from attaching themselves to the animal and being carried indoors into the owner's home or other structure.

To fully protect a pet owner's home or other structure from outdoor elements, including pests that could be inadvertently carried indoors by the pet, what is needed is a pet door, or applicator for use on a pet door, that automatically applies pesticide to the pet and with a pesticide applicator.

There are a variety of pet doors on the market and disclosed in the prior art, however, none accomplish the benefits of the various embodiments disclosed herein by Applicant.

### SUMMARY OF THE INVENTION

Accordingly, it is an objective of the present application to provide a pet door and pesticide applicator for use on a pet door featuring an affixing means operationally configured to secure the pesticide applicator to a pet door, an applicator surface disposed on the pesticide applicator, where the applicator surface is configured to receive and dispense pesticides on a pet passing through or near the pet door.

It is yet another object of the present application to provide a removable pesticide applicator that may be affixed to a pet door.

It is yet another object of the present application to provide a method of applying pesticides to domestic pets, whether “organic” or traditional pesticidal agents.

Other objectives of the invention will become apparent to those skilled in the art once the invention has been shown and described. Phrases such as “preferably” or “suitably” are also not intended as limiting, but merely exemplary of some of the embodiments contemplated by Applicant. These objectives are not to be construed as limitations of applicant's invention, but are merely aimed to suggest some of the many benefits that may be realized by the apparatus of the present application and with its many embodiments.

### BRIEF DESCRIPTION OF THE DRAWING

The manner in which these objectives and other desirable characteristics can be obtained is explained in the following description and attached drawings in which:

FIG. 1 is a front drawing of a preferable pet door incorporating a removable pesticide applicator.

FIG. 2 is a perspective drawing of a preferable removable pesticide applicator.

FIG. 3 is a perspective drawing of a preferable pet door incorporating a removable pesticide applicator.

FIG. 4 is a perspective drawing of a preferable pet door incorporating a removable pesticide applicator that has been affixed to a mounting structure and depicts a pet using the invention.

FIG. 5 is a perspective drawing of a preferred embodiment wherein a pesticide applicator is fixed to the front, rear, or both of a pet door.

FIG. 6 is a perspective drawing of a preferred embodiment of a pesticide applicator that features a variable angle between the applicator and the pet door.

FIG. 7 is a perspective drawing of a preferable embodiment of a pesticide applicator featuring an interlocking affixing means for affixing the applicator to a pet door.

FIG. 8A is a perspective view of a preferable embodiment of a pesticide applicator of a polygonal form, with FIG. 8B showing the underside and adhesive means for affixing said polygonal applicator to a pet door.

It is to be noted, however, that the appended drawings illustrate only typical embodiments of this invention and are therefore not to be considered limiting of its scope, for the invention may admit to other equally effective embodiments that will be appreciated by those reasonably skilled in the relevant arts. Also, drawings are not necessarily made to scale but are representative.

### DETAILED DESCRIPTION OF THE INVENTION

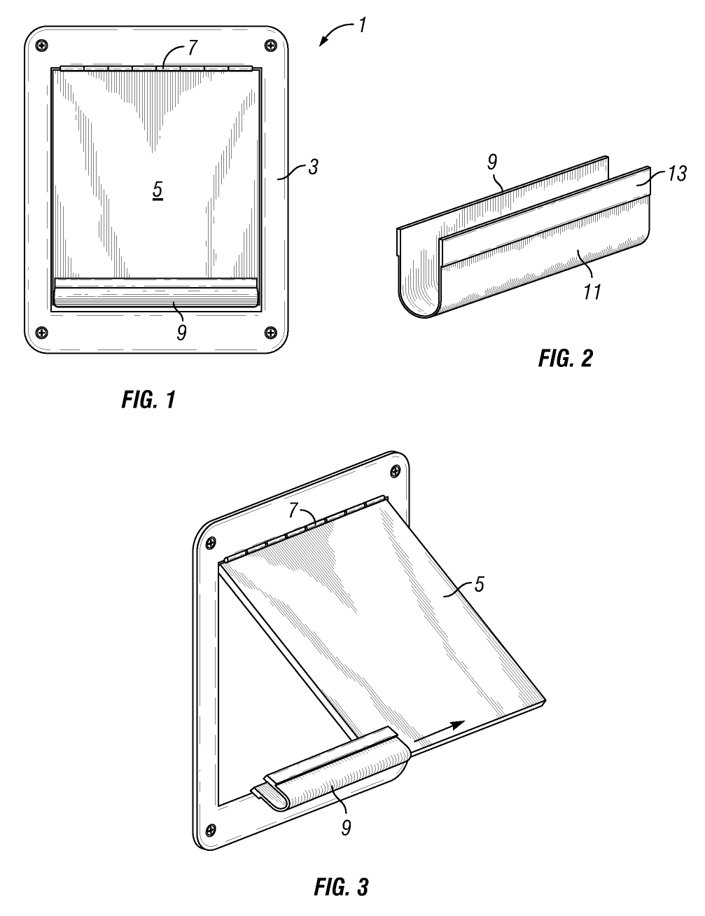

FIG. 1 is a front view drawing of a preferable embodiment of a pet door incorporating a removable pesticide applicator. Basic components of the pet door incorporating a removable pesticide applicator comprise a mounting structure 1, a frame 3, a door 5, and an applicator 9. A preferable mode of use is that an appropriately sized opening in the mounting structure 1 is created, allowing frame 3 to be affixed to the mounting structure 1. The frame 3 may be fashioned from any rigid or semi-rigid material, such as any variety of metal, plastic, rubber, wood or other compounds having these qualities. Means of affixing the frame 3 to the mounting structure 1 could include, but are not limited to: screws, bolts, nails, chemical adhesives, or interlocking affixing apparatus. The door 5 and applicator 9 may be affixed to the frame 3 concurrently with the mounting of the frame 3 to the mounting structure 1, or affixed to the frame 3 after the frame 3 is affixed to the mounting structure 1. The door 5 may be fashioned from any soft, rigid or semi-rigid material, such as any variety of metal, plastic, rubber, vinyl, wood or other compounds having these qualities. Preferably, the door 5 may be affixed to the frame 3 by a hinging means 7. Said hinging means 7 could include, but are not limited to: fasteners, adhesives, flexible materials, grooved or interlocking devices, or any other devices that are deformable or configure to allow the pet door 5 to open and close and a pet to pass therethrough. One reasonably skilled in the art could envision any variety of fastening systems that would serve a similar function. Preferably, the applicator 9 is affixed to the door 5 as described below and further detailed in FIGS. 2-8B.

FIG. 2 is a perspective drawing of a preferable removable pesticide applicator 9. Basic components of the applicator 9 may comprise an applicator surface 11 and an affixing means 13 for securing the applicator to a pet door 5. The applicator 9 is suitably configured to fix to a pet door 5. The embodiment of FIG. 2 has an affixing means 13 that interfaces with the curvatures or other shape of the bottom edge of the door 5 when affixed. The applicator surface 11 may be fashioned from any soft, rigid or semi-rigid material, such as any variety of cloth, metal, latex, plastic, rubber, vinyl or other compounds having these qualities. The applicator surface 11 contains, is impregnated with, or otherwise retains and is operationally configured to dispense or apply pesticide compounds. Said pesticide compounds may be released upon or transferred to other surfaces that come into contact with the applicator surface 11, particularly in the case of contact with a pet 15.

In this application, the term pesticide is intended to include any substance known to deter, diminish, control, or eradicate pest infestations from a pet, whether chemical or of “organic” derivatives. The term “pesticide” is used in a global sense to refer to those chemical or natural ingredients, or insecticides, which are known in the relevant industry to accomplish eradication, control, or which deter pest infestation in pets. Some suitable compounds for insect and flea control on a pet include, but are not limited to: tetrachlorvinphos, (s)methoprene, tetrachlorvinphose, phenothren, chlopyrifos, d-limonene, diazinon, dioctyl sodium sulfosuccinate (DSS), undeclyenic acid, fenvalorate, nylar, MGK 264, malathion, propoxur, pyriproxifen, limonene, linalool, piperonyl, butoxide, phenothrin, tetrachlorvinphos, carbaryl (1-Naphthyl N-methylcarbamate), pyrethrins, piperony, butoxide, N-Octyl bicycloheptene dicarboximi, and others. A variety of carbamates are used as pesticides, including but not limited to 2-isopropoxyphenyl N-methyl carbamate, 3-(1-methylbutyl) phenyl N-methyl carbamate, I-napthyl N-isopropyl carbamate, d-Limonene, diatomaceous earth, and many others. Frequently, these products may be mixed or combined to increase effectiveness. Other insecticide materials include tetrachorovinphos, which is 2-chloro-1(2,4,5-trichlorophenyl) vinyl dimethyl phosphate. Natural compounds with insecticidal or pesticide compounds include, but are not limited to peppermint oil, lavender, mint, rosemary, sweet woodruff, cedar, cinnamon oil, lemon grass oil, thyme oil, vanillin, and isoporplymristate, pyrethrum, permethrin, and rotenone sprays, among others. Further, other compounds, known as IGRs (insect growth regulators) are contemplated for use with the applicator(s) described herein. Typical IGRs include methoprene and pyriproxyfen. Applicators may also employ electrical, or high or low frequencies mechanisms to deter pests.

The applicators, in all of their embodiments, share a common feature being that they are capable of retaining pesticides. The applicators are impregnated or otherwise infused with a pesticide substance, with an end result being that the applicators retain the pesticides, but are also capable of delivering a measurable quantity of pesticide to a pet when a pet passes through the pet door 5. The pesticides may be applied to the applicator(s) by a variety of methods, which include but are not limited to, soaking, dipping, injecting, infusing, or spraying the applicators with a suitable quantity of pesticide product. The precise concentrations of such pesticides may be adjusted for user preferences, pet sizes, desired applicator lifespan, or regulatory requirements by agencies that may control use and sale of product containing such chemicals. The applicator(s) of this application, and/or applicator surfaces, may be made from a variety of materials. Suitably, they may be formed from a mixture of plastic resins and resin modifiers, the principle feature being that the applicator(s) and/or surfaces must have the appropriate release characteristics so that the active load or ingredients can escape at an appropriate rate to accomplish the pesticidal end when a pet passes through a pet door 5 and contacts, or comes suitably near, the applicator(s). Examples of some suitable applicator materials might include polyvinyl chloride, polyacrylate, and polymethacrylate esters. The resins, in some instances, might make up 20-80% by weight of a total mixture. Plasticizers might also be included to make the applicators suitably hard or flexible, such plasticizers including, but not limited to phosphoric acids, phthalic acids, or other useful esters made from adipic, maleic, myristic, palmitic, or oleic acid. As with flea collars for pets, the applicator(s) of the present application may feature other constituent compounds known in the industry, which are inert, and which may increase the bulk density of the applicator or guard against premature oxidation.

Affixing means 13 consists of an area used for attaching the applicator 9 to the surface of the door 5. Methods of attaching the affixing means 13 to the door 5 could include, but are not limited to: the applicator's u-shape tautly fitting or gripping the door, clips, chemical adhesives, grooves, snaps, zippers, ridges or interlocking affixing apparatus. A variety of embodiments of applicators are described herein, with applicators sharing a common feature of being securable to a pet door and carrying a measurable quantity of pesticide.

FIG. 3 is a perspective drawing of a preferable pet door incorporating a removable pesticide applicator. FIG. 3 depicts the applicator 9 partially removed from the door 5 to demonstrate one preferred method for fastening the applicator 9 to the door 5 using the affixing means 13. Methods of attaching the affixing means 13 to the door 5 could include, but are not limited to: the applicator's u-shape tautly fitting or gripping the door, clips, chemical adhesives, grooves, snaps, zippers, ridges or interlocking affixing apparatus. Applicators will have an affixing means for securing to a door 5, whether securely, fixedly, or releasably.

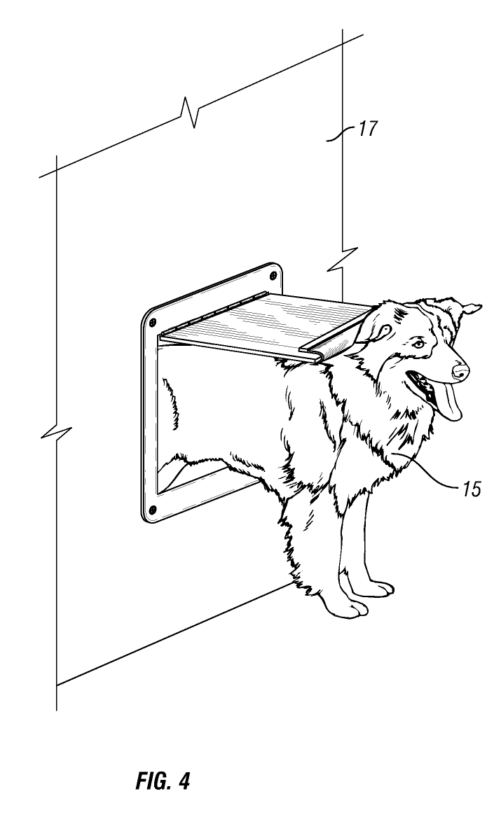

FIG. 4 is a perspective view of a suitable pet door incorporating a removable pesticide applicator that has been affixed to a mounting structure and depicts a pet using one embodiment of the invention. The pet door incorporating a removable pesticide applicator is shown affixed to a mounting structure 17. The applicator surface 11 contacts the pet 15 as the pet 15 steps through the pet door. The pet 15 may be any variety or species of pet kept by the pet owner. Disclosed are a pet door comprising a frame 3; a door 5 attached to the frame 3 by a hinging means 7; and an applicator 9 attached to the door 5 by an affixing means. Disclosed is an applicator 9 operationally configured to removably affix to a door 5, and where said applicator is preferably impregnated and capable of dispensing insecticide on a pet passing through said door 5. Further disclosed is a method of treating pets with an insecticide comprising the steps of impregnating an applicator with a pesticide; affixing said impregnated applicator 9 to a pet door; allowing pet to pass through said pet door, whereupon said pet is exposed to a quantity of pesticide.

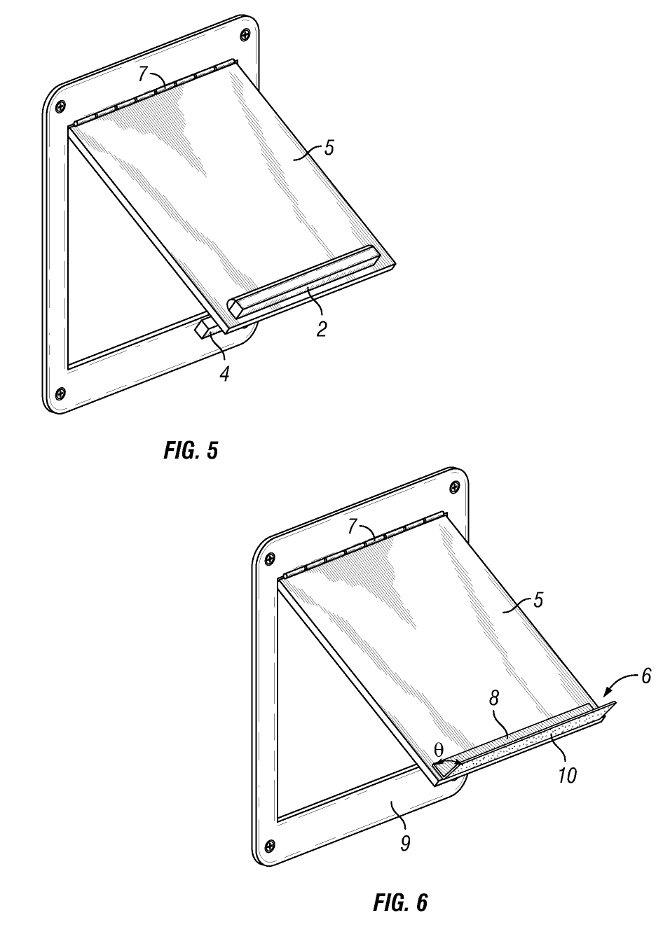

FIG. 5 is an alternate embodiment of an applicator in a substantially rectangular form, where a first applicator 2 is affixed to a lower first side of said the door 5 and where a second applicator 4, may also be suitably attached to a second side of the door 5. A preferable affixing means to door 5 is an adhesive means. It is contemplated that the applicator(s) may feature a strip of adhesive that may be selectively removed by the user prior to securing the applicator(s) to said door. For instance, a double-sided adhesive tape or comparable means might be used. This particular applicator embodiment is of a porous material, for instance, sponge whereupon pesticide is readily absorbed and retained. The applicator(s) may be purchased by consumers in quantities and in strengths that may be required for a particular sized pet, habitat, or specific offending pests.

FIG. 6 is yet another embodiment of the applicator, where such angled applicator 6 may form either a fixed or variable angle between the door 5 and a surface of said angled applicator 6. The angled applicator 6 has a contact surface 10 and a fixing surface 8. An angle in the range of 90 to 170 degrees is preferable for contact with the back of a pet. The angled applicator 6 may also have a flexible or variable angle so that contact with a pet causes the applicator 6 to bend, thereby more effectively delivering a dose of pesticide as the pet moves through the frame. In this embodiment, a paper or flexible plastic is particularly suitable. The fixing surface 8 features an adhesive backing so that it may be fixed to the door 5, preferably at a lower portion of the door 5, where the contact surface 10 (housing pesticide) will extend just beneath door 5.

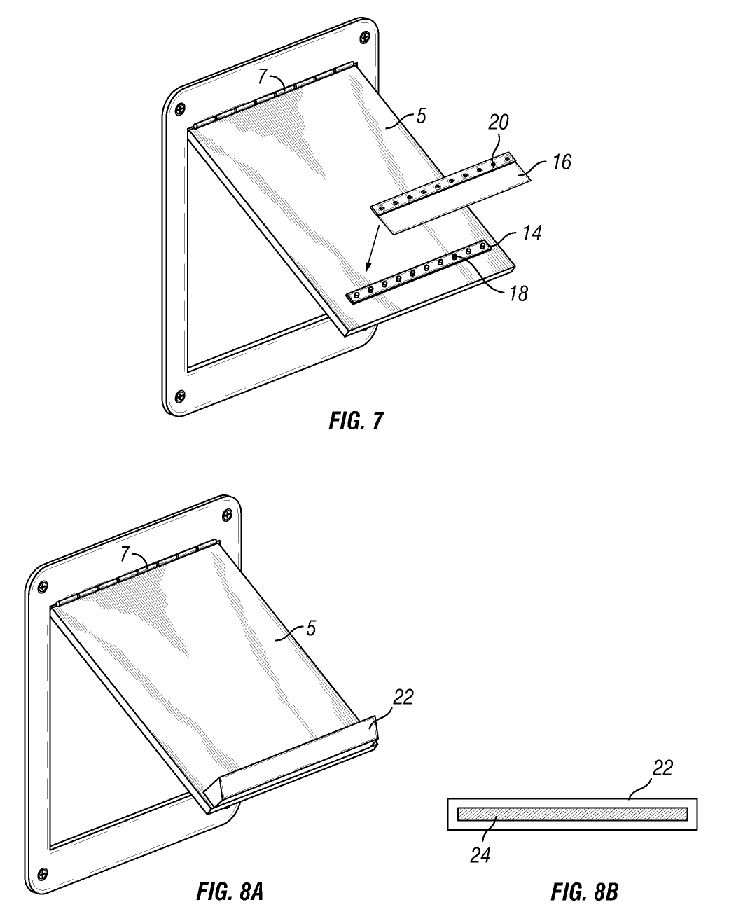

FIG. 7 is yet another embodiment of a pesticide applicator for a pet door 5, where said applicator features an interlocking mechanism for securing to the door 5. Depicted is a two-piece connecting means with a first connector 14 (affixed to said door 5) and a second connector 12 for affixing to said first connector 14. In the instant drawing, the first connector 14 features at least one protuberance operationally configured to couple with at least one complimentary receiver 20 located in said second connector 12. A pesticide strip 16 is located on the second connector 12 so that when first connector 14 and second connector 12 are coupled, the pesticide strip 16 is affixed to the door and may be used to deliver a dose to the recipient animal. This arrangement could feature any variety of interlocking mechanisms or means to secure a first 14 and second 12 connector, but a principle advantage of this arrangement is that the pesticide strip may be disposed of when finished, and that the consumer can purchase and add new inserts as necessary. As with all of the applicators in this application, they may be applied to one or both sides of door 5.

FIG. 8A is a perspective view of yet another embodiment for the application, where a polygonal applicator 22 is affixed to the door 5. FIG. 8B shows an adhesive band 24 that is used to fix such a polygonal applicator 22 to said door.

Disclosed is a pesticide system for use with a pet comprising: a pet door disposed within a frame; said frame being operationally configured to be fixed in a structure; said pet door connected by a hinging means to said frame; at least one applicator removably coupled to said pet door, said applicator having an affixing means for connecting to said pet door and an applicator surface configured thereon to retain pesticide; whereby a pet passing through or under said pet door receives a measurable dose of pesticide. Further disclosed is a pesticide applicator further comprising an affixing means that grips both sides of the lower portion of said pet door. Further disclosed is a pesticide applicator comprising an affixing means that has a substantially U-shape that is operationally configured to grasp an edge of said pet door. Further disclosed is a pesticide applicator further comprising an affixing means that is an adhesive. Further disclosed is a pesticide applicator further comprising an affixing means that is an adhesive tape, wherein a removable protective strip is used to prevent exposing the adhesive thereon to air prior to securing said applicator to said pet door. Further disclosed is a pesticide applicator wherein said affixing means is an angled applicator. Further disclosed is a pesticide applicator wherein said affixing means further comprises a first connector and second connector operationally configured to interlock with one another; said second connector being removably attachable to said first connector; said second connector featuring an applicator surface that retains pesticide. Further disclosed is a pesticide applicator wherein said first connector features at least one protuberance that couples with at least one complimentary receiver disposed on said second connector. Further disclosed is a pesticide applicator that defines a polygonal shape. Disclosed is a pesticide applicator for use on a pet door comprising: an affixing means operationally configured to removably or permanently secure said pesticide applicator to a pet door; an applicator surface disposed on said pesticide applicator, said applicator surface configured to receive and dispense pesticides on a pet passing through or near said pet door. Disclosed is a pesticide applicator further comprising an affixing means that grips both sides of the lower portion of said pet door. Disclosed is a pesticide applicator further comprising an affixing means that has a substantially U-shape, operationally configured to grasp the lower edge of said pet door. Disclosed is a pesticide applicator further comprising an affixing means that is an adhesive. Disclosed is a pesticide applicator further comprising an affixing means that an adhesive tape, wherein a removable protective strip is used to prevent exposing the adhesive thereon to air prior to securing said affixing means to said pet door. Disclosed is a pesticide applicator wherein said affixing means is an angled applicator. Disclosed is a pesticide applicator wherein said angled applicator defines an angle between said pet door and a contact surface in the range of 90 and 170 degrees. Disclosed is a pesticide applicator wherein said affixing means further comprises a first connector and second connector configured to interlock with one another; said second connector being removably attachable to said first connector; said second connector featuring an applicator surface that retains pesticide. Disclosed is a pesticide applicator, wherein said first connector features at least one protuberance that couples with at least one complimentary receiver disposed on said second connector. Disclosed is a pesticide applicator, wherein said applicator further defines a polygonal shape. Further disclosed is a method of treating a pet for pests comprising the steps of: obtaining an applicator impregnated with pesticides; fixing said applicator impregnated with said pesticides to a pet door; allowing a pet to pass through said pet door; and, dispensing a measurable dose of said pesticide to said pet as it passes through the structure.

It is to be noted, however, that the appended drawings illustrate only typical embodiments of this invention, are not to scale, and are therefore not to be considered limiting of its scope, for the invention may admit to other equally effective embodiments which are appreciated by those skilled in the arts.

I claim:

1. A pesticide system for use with a pet comprising:
A pet door disposed within a frame;
Said frame being operationally configured to be fixed in a structure;
Said pet door connected by a hinging means to said frame;
At least one applicator removably coupled to said pet door, said applicator having an affixing means for connecting to said pet door and an applicator surface configured thereon to retain pesticide;
whereby a pet passing through or under said pet door may receive a measurable dose of pesticide.

2. The pesticide applicator of claim 1 further comprising an affixing means that grips both sides of the lower portion of said pet door.

3. The pesticide applicator of claim 1 further comprising an affixing means that has a substantially U-shape that is operationally configured to grasp an edge of said pet door.

4. The pesticide applicator of claim 1 further comprising an affixing means that is an adhesive.

5. The pesticide applicator of claim 1 further comprising an affixing means that is an adhesive tape, wherein a removable protective strip is used to prevent exposing the adhesive thereon to air prior to securing said applicator to said pet door.

6. The pesticide applicator of claim 1 wherein said affixing means is an angled applicator.

7. The pesticide applicator of claim 1 wherein said affixing means further comprises a first connector and second connector operationally configured to interlock with one another;
said second connector being removably attachable to said first connector;
said second connector featuring an applicator surface that retains pesticide.

8. The pesticide applicator of claim 8, wherein said first connector features at least one protuberance that couples with at least one complimentary receiver disposed on said second connector.

9. The pesticide applicator of claim 1, wherein said applicator further defines a polygonal shape.

10. A pesticide applicator for use on a pet door comprising:
An affixing means operationally configured to secure said pesticide applicator to a pet door;
An applicator surface disposed on said pesticide applicator, said applicator surface configured to receive and dispense pesticides on a pet passing through or near said pet door.

11. The pesticide applicator of claim 10 further comprising an affixing means that grips both sides of the lower portion of said pet door.

12. The pesticide applicator of claim 10 further comprising an affixing means that has a substantially U-shape, operationally configured to grasp the lower edge of said pet door.

13. The pesticide applicator of claim 10 further comprising an affixing means that is an adhesive.

14. The pesticide applicator of claim 10 further comprising an affixing means that an adhesive tape, wherein a removable protective strip is used to prevent exposing the adhesive thereon to air prior to securing said affixing means to said pet door.

15. The pesticide applicator of claim 10 wherein said affixing means is an angled applicator.

16. The pesticide applicator of claim 15 wherein said angled applicator defines an angle between said pet door and a contact surface in the range of 90 and 170 degrees.

17. The pesticide applicator of claim 10 wherein said affixing means further comprises a first connector and second connector configured to interlock with one another;
said second connector being removably attachable to said first connector;
said second connector featuring an applicator surface that retains pesticide.

18. The pesticide applicator of claim 10, wherein said first connector features at least one protuberance that couples with at least one complimentary receiver disposed on said second connector.

19. The pesticide applicator of claim 10, wherein said applicator further defines a polygonal shape.

20. A method of treating a pet for pests comprising the steps of:
Obtaining an applicator impregnated with pesticides;
Fixing said applicator impregnated with said pesticides to an a pet door;
Allowing a pet to pass through said pet door; and,
Dispensing a measurable dose of said pesticide to said pet as it passes through the pet door.
